(19) United States
(12) Patent Application Publication
(10) Pub. No.: US 2002/0162883 A1
(43) Pub. Date: Nov. 7, 2002

(54) Package delivery and pickup receptacle system with mailbox and newspaper receptacle

(76) Inventors: Richard Henry Arvonio, Alexandria, VA (US); Lawrence Russell Baumiller, Fairfax Station, VA (US)

Correspondence Address: Richard H. Arvonio, 6770 Edge Cliff Drive, Alexandria, VA, 22315-2603, US

(21) Appl. No.: 09/797,603

(22) Filed: Mar. 5, 2001

(51) Int. Cl. B65G 11/04

(52) U.S. Cl. 232/45

(57) ABSTRACT

A package delivery and pickup receptacle system where packages can be delivered to a secure and weatherproof receptacle by delivery firms regardless of the availability of the customer to receive the package. In addition, a customer may place packages in this secure and weatherproof receptacle for pickup service by delivery firms at any time. This receptacle may be fabricated from metal, high-impact polymers or plastics or other suitable materials. Its integrated components include an interior divider shelf to accommodate small and large packages together or larger single packages. The receptacle has a split or “Dutch style” or split front locking door for security that is hinged on the left side of the receptacle to permit easy access from a delivery vehicle approaching from the right-side of the roadway. The “Dutch style” or split front door allows the upper locking door to be opened as access for smaller packages to be deposited or picked up without the need to opening both sections of the door. Conversely, both sections of the door can be opened simultaneously when larger packages or more than one package is to be deposited. Because of the overlapping design of the split front door, the bottom door, held closed by a spring-loaded T-bar, cannot be opened without unlocking and opening the upper door. A cam lock assembly or other suitable locking assembly may be used on the upper door that provides for a universal key that can be used by all delivery firms to unlock the upper door. In addition, the consumer would obtain keys when the unit is purchased.

It also includes a dual purpose, signaling device that alerts the customer that a package has been delivered and a specified delivery firm when a package has been placed inside by the customer for pickup service. The base unit of the package delivery and pickup receptacle has a base unit that consists of a welded base plate with supports and mounting channels for ease of installation, added stability and automatic height adjustment to meet delivery requirements.

CROSS-REFERENCE TO RELATED APPLICATIONS

| | | | |
|---|---|---|---|
| D254635 | Apr., 1980 | Earle | D99/033 |
| 4333603 | Jun., 1982 | Carlson | 232/017 |
| 4602721 | Jul., 1986 | Hicks | 220/337 |
| 4848650 | Jul., 1989 | Roberts, II | 232/017 |
| D324444 | Mar., 1992 | Cummings | D99/031 |
| 5407127 | Apr., 1995 | Worden | 232/017 |
| 5573178 | Nov., 1996 | Worden | 232/024 |
| D385681 | Oct., 1997 | Worden | D99/031 |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Package delivery firms follow a variety of procedures when delivering packages to residential or business addresses. For example, the U.S. Postal Service (USPS), United Parcel Service (UPS), and Federal Express (FEDEX) deliver packages by dispatching a carrier, courier or driver to a delivery address (residential or business). The driver attempts to deliver the package to the consumer and when a person is available to accept delivery of a package the service is effected or complete. However, there are a number of circumstances that impact the ability of delivery firms to effect delivery, particularly when an individual is not available to accept the package being delivered. For security purposes or to prevent potential damage from inclement weather, shippers may require delivery to be made only when an individual is available to accept the package and may even require a signature to verify acceptance. In these situations, delivery firms are instructed not to leave the package unless it is accepted. When a delivery firm cannot effect delivery as described above and cannot leave the package at the delivery address, a notice is normally left that an attempt has been made to deliver a package. For example, if the U.S. Postal Service is the delivery firm that attempted delivery, a yellow notice is left in the mailbox advising them to pick the package up at a specific location (post office), during specified hours and within a certain timeframe or the package will be returned to sender. Other delivery firms may make subsequent attempts to deliver the package and in some cases will be unsuccessful in their attempts. When this occurs, delivery may be delayed or the package returned to the sender because of unsuccessful attempts at delivery. This results in customer inconvenience and additional costs for the merchandiser and delivery firms due to failed delivery attempts and returned merchandise.

In most cases, however, shippers allow the delivery firm to leave the package even though a customer is not available to accept it. When the shipper wants a package left at a residential or business address where there is no one available to accept it, delivery firms frequently leave packages in a variety of locations. For example, the package may be left on the doorstep; behind bushes; in the rear yard; or at a neighbor's home. When this occurs, the driver will leave a notice on the front door indicating where the customer can find the package.

Weather conditions also complicate delivery when a customer is not available to accept a package. During inclement weather, packages may or may not be wrapped in plastic and placed in one of the locations described above. This not only adds costs to the delivery firm for the added delivery materials (plastic wrap or bags) but also subjects packages to potential damage from inclement weather.

Further complicating and adding costs to the delivery process is the security issue. Packages left on doorsteps, behind bushes or in rear yards are prime targets for theft. When customers' report that they have not received the goods they have ordered and an apparent theft has occurred, the merchandiser, in most cases, will send a replacement package to fulfill the customer's order. The merchandisers must absorb the losses, ultimately increasing their costs.

There is also the issue of package returns. Today, if a package is to be returned by the consumer there are different procedures for the varying delivery firms. If the package is to be returned via the U.S. Postal Service, the customer must go to the post office during normal business hours, which can be an inconvenience to the customer. If the package is to be returned via UPS, the customer must call the merchandiser (if they indicate a paid return service) and the merchandiser will have them place the package at the front door for pickup within a specific number of days. This requires the customer to leave a package outdoors; in front of their residence or business, and at time for a number of days to ensure it is there when the driver does stop for the pickup. This process also subjects the packages to possible theft or damage from inclement weather. If the merchandiser has not specified a paid return service and the customer is returning the package via UPS, they must go to a UPS facility for shipping during normal business hours, again, a potential inconvenience to the customer.

There continues to be phenomenal growth in the use of the Internet as an information, communications and merchandising media. An increasing number of retailers, catalogers and merchandisers are utilizing the Internet as a cost-effective, safe and secure method for advertising their products and services versus the traditional retail environment or mail order.

The ability for consumers to order and pay for products, merchandise and services, with a high degree of confidence on-line via the Internet, as a safe and secure method for financial transactions has become a reality. And offering consumers a secure and safe method for placing orders and making payments online via the Internet is a convenient and cost effective alternative for companies offering their products and services. Based on the current trend in consumer shopping and purchasing, predictions are that the Internet, on-line shopping is experiencing explosive growth. The Internet is becoming a “shopping mecca” for consumers in that their shopping and purchasing habits have been altered forever.

However, what's slowing things down in E-tailing, as it is now called, is the actual physical delivery of the merchandise to consumers' front door. Buying over the Internet is supposed to make life easier for shoppers. But that is not the case when a package has to be picked up at a delivery firm's retail outlet days later because no one was home when the delivery courier attempted delivery.

With the explosive growth in the number of purchases via the Internet versus the traditional retail environment and mail order, there is an even greater demand for package delivery and pickup services in countries around the world. And these services are a critical element to the overall effectiveness and success of the online shopping experience for both merchandisers and consumers. While the number of consumer orders is growing at an explosive rate, the number of packages that must be delivered to or picked up from the consumer household or business is growing exponentially!

Currently, there is no consumer product in the marketplace for households or businesses that provides a safe, secure and weatherproof receptacle where packages can be delivered when the consumer is unavailable to accept delivery. Neither is there a safe, secure and weatherproof receptacle for consumers to deposit a package for pickup service.

### BRIEF SUMMARY OF THE INVENTION

In view of the foregoing, it is an object of the present invention to provide, as a consumer product, a package delivery and pickup receptacle system that enables the delivery of packages on the first attempt by the delivery firms, regardless of whether the consumer is available to physically accept a package.

It is a more particular object of the present invention to provide a safe, secure and weatherproof package delivery and pickup receptacle system that protects packages from possible theft and damage due to weather conditions.

It is another object of the present invention to provide the consumer with a safe, secure and weatherproof package delivery and pickup receptacle system receptacle into which the consumer may place packages that are to be picked-up by delivery services.

It is another object of the present invention to incorporate a locking mechanism that provides a master key for delivery firms to gain access to the package delivery and pickup receptacle system. Each package delivery and pickup receptacle system would have a unique key for the consumer to retrieve delivered packages or to deposit packages for pickup. Each delivery firm would be provided a master key that could be duplicated for use on all of that delivery firm's delivery routes. The master keys would be considered a security or accountable item for the delivery firms.

It is another object and the preferred embodiment of the present invention to incorporate a U.S. Mailbox and newspaper receptacle into the overall design of the package delivery and pickup receptacle system. When incorporated in this manner and to permit all delivery service firms (other than the U.S. Postal Service), to deposit or pickup packages, the package delivery and pickup receptacle system that serves as the post for the U.S. Mailbox.

In view of these objects and other objects that become evident from the description of the preferred embodiments of the invention herein, an improved package delivery and pickup receptacle system is disclosed. The package delivery and pickup receptacle system broadly includes an enclosure for enclosing packages that are delivered and those being returned or sent out by the consumer that are intended to be picked up by a delivery or pickup firm. In addition, it includes a pickup signaling device that alerts various delivery firms that a package has been placed is inside by the customer for pickup.

In more detail, the enclosure includes double “dutch” style front doors with a mechanism for securing the bottom door when the upper door is opened. The design of the door hinge into the left side of the package delivery and pickup receptacle system provides easy access for delivery from the delivery vehicle's right side door as the vehicle approaches the receptacle from the right side of the street. Conversely, in countries where driving on the left side of the street is the norm, the door hinge may be manufactured into the right side of the receptacle.

The package delivery and pickup receptacle system may be manufactured using metal, high-impact polymers, plastics, or other suitable materials. The package delivery and pickup receptacle system provides a lockable, secure system for the delivery of packages that acts as a deterrent to theft. Its locking exterior “Dutch” door design makes it possible for multiple packages to be delivered on any given day by the same or different delivery firms. The internal construction, with an adjustable shelf (or shelves), provides flexibility for the delivery of packages of varying sizes and also acts as a separator between packages as added protection against potential damage if heavy weight packages are stacked on top of lighter packages. Overall, its design provides a weatherproof system that prevents the potential damage that would otherwise occur if packages were left outdoors at residential or business addresses.

Conversely, the package delivery receptacle is the only consumer product that, for the first time, offers consumers a receptacle where they may leave a package outside of their residence or business, for pickup service by a delivery firm without worrying about possible theft or damage from the weather.

Merchandisers may request consumers to leave packages of returned merchandise in a package delivery and pickup receptacle system for pickup by a delivery firm without worrying how many days it may take before the package is picked up and without worry of possible theft or damage from unexpected weather conditions. In essence, the package delivery and pickup receptacle system offers consumers, merchandisers and delivery firms both physical security and safeguards from the weather until pickup service is provided.

The package delivery and pickup receptacle system provides a significant number of benefits to the merchandiser (shipper), delivery firm, consumer, and the economy. The following describes many of the benefits that can be attained when the package delivery and pickup receptacle system is installed and utilized by consumers for over the delivery and pickup of approximately 90% of the sizes of packages currently delivered:

Merchandisers (Shipper) Benefits:

All packages delivered on first attempt to a secure receptacle.

Decreased product and shipping costs currently associated with weather damaged merchandise when packages are left outdoors.

Decreased product and shipping costs currently associated with the theft of merchandise when packages are left outdoors.

Decreased shipping costs currently associated with packages returned for non-delivery by the delivery firm.

Increased customer satisfaction when packages are delivered in a timely manner.

Increased customer satisfaction when the customer does not have to travel to a delivery firm's retail facility to pickup or return packages that were unable to be delivered on previous attempts or are being returned to the merchandiser.

Increased potential for satisfied customers to become repeat customers, increasing orders and revenues.

Convenient first time, everytime delivery and pickup service for consumers at a residence or place of business.

Greater delivery reliability, confidence in service and package security.

Package Delivery Firm Benefits:

Cost savings, efficiencies and service goals are achieved when delivery is accomplished on the first attempt without the need to determine whether the consumer is available to accept a package.

Higher confidence in delivery service when packages are safe from the elements and more secure from theft.

Reduced delivery costs when drivers can deliver packages to the receptacle without leaving the vehicle versus the need to leave vehicle to deliver packages to the door.

Reduced delivery costs when driver does not need to leave attempted delivery slip at door.

Reduced delivery costs when driver does not need to leave the vehicle and determine appropriate place to leave the package (i.e., doorstep, behind bushes, in rear yards, etc.).

Reduced delivery costs when driver does not spend additional time placing packages in plastic wrap or bags to leave outdoors in the event of inclement weather.

Reduced delivery costs with the elimination of plastic wrap or bags and notices for packages currently left outdoors.

Reduced delivery costs by eliminating the need to return parcels to the delivery firm's facility for storage of packages when delivery attempts fail.

Shippers have more confidence in the delivery services and are more willing to have packages left regardless of whether consumers are available to accept and sign for packages, resulting in cost savings and service improvements for both the shipper and delivery firm.

Increased capacity in the delivery firm's system through the identified savings achieved from first-time, everytime delivery.

Increased business opportunity and capacity in vehicles for pickup service to be provided simultaneously with the delivery service.

Consumers Benefits:

Packages will always be delivered regardless of consumers' availability to accept delivery.

Packages and merchandise will always be protected from inclement weather.

Packages are in a more secure container than on doorsteps, behind bushes or in rear yards, deterring theft.

Eliminates inconvenience of going to a delivery firm's retail store for pickup of undelivered packages or to return packages of unwanted merchandise.

Eliminates inconvenience of calling package delivery firms to have a package redelivered after the first attempt failed or for package pickup service.

Simplifies return process for merchandise returns paid by shippers, eliminating need for consumers to go to delivery firms' retail stores for service.

Increases consumer satisfaction with improved delivery and pickup service.

Economic Benefits:

Increased timeliness and reliability of delivery increases customer satisfaction.

Service improvements and cost savings are achieved thereby increasing productivity.

Greater capacity to handle the explosive growth of on-line Internet purchases when packages are delivered first time, every time versus returning packages to the delivery firm's facility or merchandiser.

Increased customer satisfaction increases customer orders.

Increased customer orders increase demand.

Increased demand creates jobs.

### BRIEF DESCRIPTION OF THE SEVERAL VIEWS OF THE DRAWING

The accompanying drawings, which are incorporated in and constitute a part of the application, illustrate the embodiment of the invention, and together with the general description given above and the detailed description of the preferred embodiment given below, serve to explain the principles of the invention.

FIG. 1 is a perspective view of the preferred embodiment of the package delivery and pickup receptacle system which includes the U.S. mailbox, newspaper receptacle, main cabinet unit, assembled base unit assembly and signaling system of the present invention.

FIG. 2 is a perspective view of the preferred embodiment of the package delivery and pickup receptacle system with the both front doors open showing two-cutaway views.

FIG. 3 illustrates an exploded view of the front elevation of the package delivery and pickup receptacle system with a mailbox and newspaper receptacle incorporated within the design of the preferred embodiment of the present invention.

FIG. 4 illustrates a view of the exploded right side elevation of the package delivery and pickup receptacle system with the mailbox and newspaper receptacles incorporated within the design of the present invention. The mailbox and newspaper receptacles are optional to the design. When they are incorporated the package delivery and pickup receptacle system would service as the post for these two optional components.

FIG. 5 illustrates a view of the front elevation of the package delivery and pickup receptacle system with the split doors front open to reveal the interior shelf and supporting angle components with the left-side hinge construction of the present invention.

FIG. 6 illustrates a front elevation view of the front split panel door of the package delivery and pickup receptacle system showing a view of the top door's locking mechanism key hole location and the left-hand piano hinges of the top and bottom doors of the present invention.

FIG. 7 illustrates a side cutaway view of the interior of the split front panel door of the package delivery and pickup receptacle system showing the top door's locking assembly, T-bar bottom door locking assembly, the top and bottom door piano hinges and the overlapping weatherproof door edges of the present invention.

FIG. 8 illustrates a view from the back of the main cabinet unit assembly looking forward towards the interior of the split front panel doors of the package delivery and pickup receptacle system showing the T-bar bottom door locking assembly, the interior of the upper door lock mechanism and the top and bottom door piano hinges of the present invention.

FIG. 9 illustrates a front elevation view of the T-bar bottom door, locking assembly of the package delivery and pickup receptacle system of the present invention.

FIG. 10 illustrates a cutout view from the left side of the package delivery and pickup receptacle system showing the T-bar bottom door, locking assembly attached to the bottom front door of the present invention, locking over the bottom edge of the main cabinet unit.

FIG. 11 illustrates a view of the top elevation of the package delivery and pickup receptacle system showing the top of the upper split front door and the top of the pickup signal device of the present invention.

FIG. 12 illustrates a cut out view (1-1 of FIG. 2) from the left side of the package delivery and pickup receptacle system showing the support angle for the interior shelf, the T-bar bottom door locking assembly and the overlapping design of the top and bottom split front doors of the present invention.

FIG. 13 illustrates a view of the interior side of the top and bottom split front doors of the present invention showing the T-bar bottom door locking assembly.

FIG. 14 illustrates a view of the front elevation of the base unit assembly of the package delivery and pickup receptacle system showing the support and cabinet mounting channels, welded base plate, the steel collar for mounting the base unit on a wooden post and the steel flange provided as an option for mounting the base unit on a concrete pad of the present invention.

FIG. 15 illustrates a view of the front elevation of the cover plate for the base unit assembly of the package delivery and pickup receptacle system of the present invention.

FIG. 16 illustrates a top view of the base unit assembly of the package delivery and pickup receptacle system showing the support and cabinet mounting channels, the welded base plate and cover plates of the base unit of the present invention.

FIG. 17 illustrates a view of the bottom of the base unit assembly of the package delivery and pickup receptacle system showing the steel, mounting collar and the steel flange for mounting on a concrete pad of the present invention.

FIG. 18 illustrates a left side elevation view of the assembled base unit assembly of the package and anchoring lag bolt holes of delivery and pickup receptacle system of the present invention.

FIG. 19 illustrates a cutaway view (3-3 from FIG. 20) of the signaling device for pickup service of the package delivery and pickup receptacle system of the present invention.

FIG. 20 illustrates a front view of the housing of the signaling device for pickup service of the package delivery and pickup receptacle system of the present invention.

FIG. 21 illustrates a view of the interior nameplate of the signaling device for pickup service of the package delivery and pickup receptacle system of the present invention.

FIG. 22 illustrates a cutout view (1-1 from FIG. 2) looking from the left side through to the interior of the right side panel of the package delivery and pickup receptacle system showing location and various setting of the signaling device for pickup service of the present invention.

FIG. 23 illustrates a top view (2-2 from FIG. 2) of the divider shelf and hinge of the package delivery and pickup receptacle system showing the cutout in the shelf that provides access to the T-bar bottom door locking assembly of the present invention.

FIG. 24 illustrates a front view of the interior divider shelf of the package delivery and pickup receptacle system showing the hinged left side and right side angle support of the present invention.

FIG. 25 illustrates a view of the front elevation of the mailbox and newspaper receptacle assembly of the package delivery and pickup receptacle system showing the mounting bars for the optional components for mounting on the preferred embodiment of the present invention.

FIG. 26 illustrates a right side view of the mailbox unit and mounting channel for mounting on the package delivery and pickup receptacle system of the preferred embodiment present invention.

### DETAILED DESCRIPTION OF THE INVENTION

A unique reference or identification number has been assigned to individual parts or components and those numbers have been used throughout the various figures to designate them for consistent identification. These reference numbers for parts or components have been grouped around major sections of the package deliver and pickup receptacle system as follows:

Part # 01 Assembled Package Delivery and Pickup Receptacle System with U.S. Mailbox and Newspaper Receptacle the Preferred Embodiment of Present Invention

Parts Number 10 Through 19 Components of the Main Cabinet Unit

Part #10 Complete main cabinet unit assembly

#11 Divider shelf between the top of the cabinet and the bottom, in the down position it will hold a smaller parcel(s) and in the up position for larger parcels

#12 Angle support for the divider shelf Part #11

#13 Hinge for divider shelf Part #11

#14 Upper door with top and bottom edge overlapping, weatherproofing design that covers main cabinet unit

#15 Lower door with top and bottom edge overlapping, weatherproofing design that covers main cabinet unit

#16 Piano hinge on upper door

#17 Piano hinge on lower door

#18 Magnet or Velcro fastener to hold shelf when in the up position for larger parcels

#19 Mounting bars for mailbox and newspaper receptacle units

Parts Numbered 20 Through 27 Components of Assembled Base Unit Assembly

Part #20 Assembled base unit assembly

#21 Support and Cabinet mounting Channels

#22 Welded Base Plate

#23 Square steel collar for mounting base unit with 4″×6″ treated lumber post, this assembly is designed for standard height uniformity with U.S. Postal Service delivery standards (42 inch maximum)

#24 Steel flange for mounting base unit on concrete pad

#25 Base unit Cover plate

#26 Bolts for mounting cabinet to base unit (not shown)

#27 Locking Washers for mounting cabinet to base unit (not shown)

Parts Numbered 30 Through 38 Components of the Pick-up Signaling Device

Part #30 Pick-up Signal Cover

#31 Colored Delivery Firm Alert Dial

#32 Spring

#33 Alert cover locking nut

#34 Delivery Firm Alert indicator selector

#35 Delivery Firm Identification Labels on the inside of the cabinet sidewall

#36 Delivery Firm Identification Labels on the inside of the cabinet sidewall

#37 Delivery Firm Identification Labels on the inside of the cabinet sidewall

#38 Delivery Firm Identification Labels on the inside of the cabinet sidewall

Parts Numbered 40 Through 46 Combined U.S. Mailbox and Newspaper Receptacle

Part #40 Complete mailbox and newspaper receptacle unit

#41 U.S. Mailbox receptacle

#42 Front Door to U.S. Mailbox receptacle

#43 Newspaper receptacle

#44 Flag to alert carrier

Parts Numbered 50 Through 53 T-Handle Unit Assembly for Bottom Split Door

Part #50 T-Handle unit assembly

#51 Handle and Rod

#52 Spring

#53 Brackets

Parts Numbered 60 Through 62 Lock Assembly Unit

Part #60 Standard National Cam-Lock Unit

#61 Key Hole for cabinet

Parts Found in Multiple Sections of the Package Delivery and Pickup Receptacle System

Part #70 Predrilled or preformed mounting holes are found in the mounting bars on top of the main cabinet unit, in the bottom of the main cabinet unit and in the top and side of the base unit.

While the form used in the figures is that of a package delivery and pickup receptacle system, it should be understood that this form or design is used for the purposes of illustration and not of limitation. The present invention may be embodied in other specific designs or forms without departing from the spirit, essential attributes or the embodiments of the present invention.

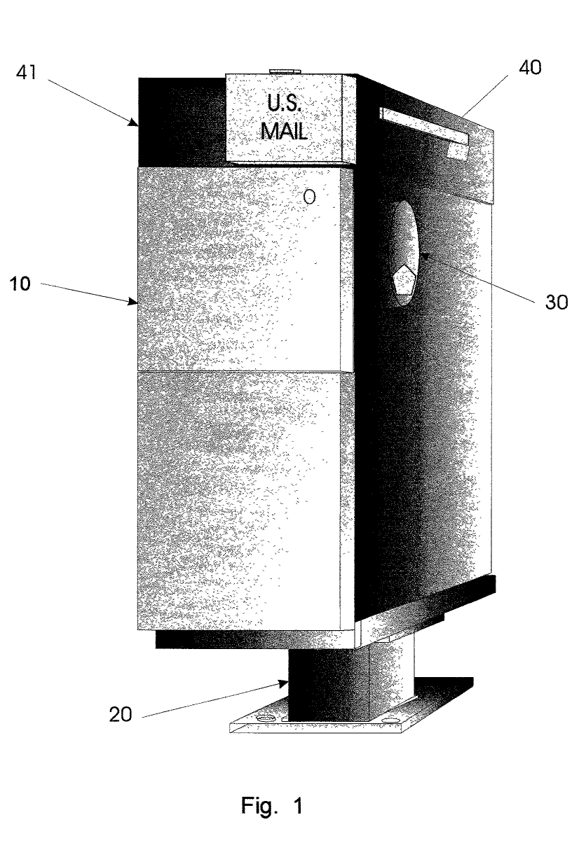

Shown in FIG. 1 is a perspective view of the preferred embodiment of the present invention that is the package delivery and pickup receptacle system generally identified as 01 with U.S. Mailbox 41 and newspaper receptacles 43 (combined unit 40) attached. The package delivery and pickup receptacle system 01 with U.S. Mailbox 41 and newspaper receptacle 43 may be manufactured using metal, high-impact polymers or plastics or other suitable materials.

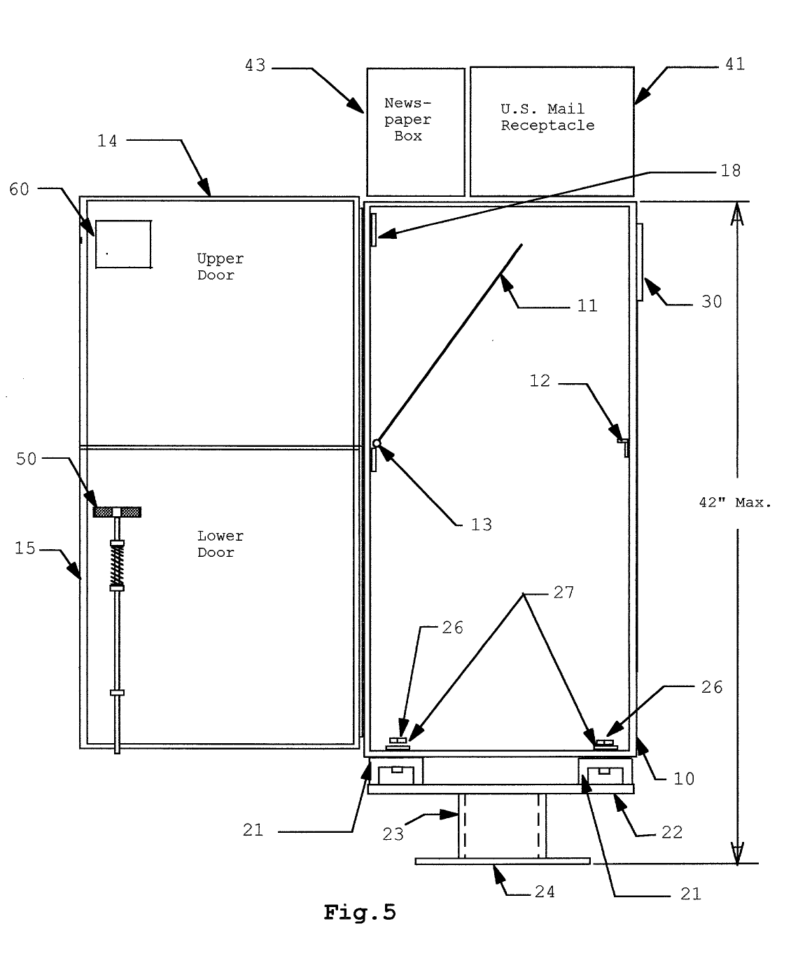

The package delivery and pickup receptacle system's 01 main cabinet unit assembly 10 is designed in such a manner that its height, in addition to the assembled base unit assembly 20, as shown in FIGS. 1, 2, 3, 4, and 5 allows the package delivery and pickup receptacle system 01 to be easily installed at a uniform standard height to accommodate delivery vehicles. When the U.S. Mailbox 41 and newspaper receptacle 43 (combined unit 40) is included as part of the package delivery and pickup receptacle system 01 (the preferred embodiment of the present invention) as shown in FIGS. 1 through 5, and is properly installed according to the manufacturers directions, the main cabinet unit 10 and the assembled base unit assembly 20 becomes a support post that supports and automatically sets the height of the U.S. Mailbox 41 in accordance with U.S. Postal Service standards (42 inches maximum height) (FIG. 5).

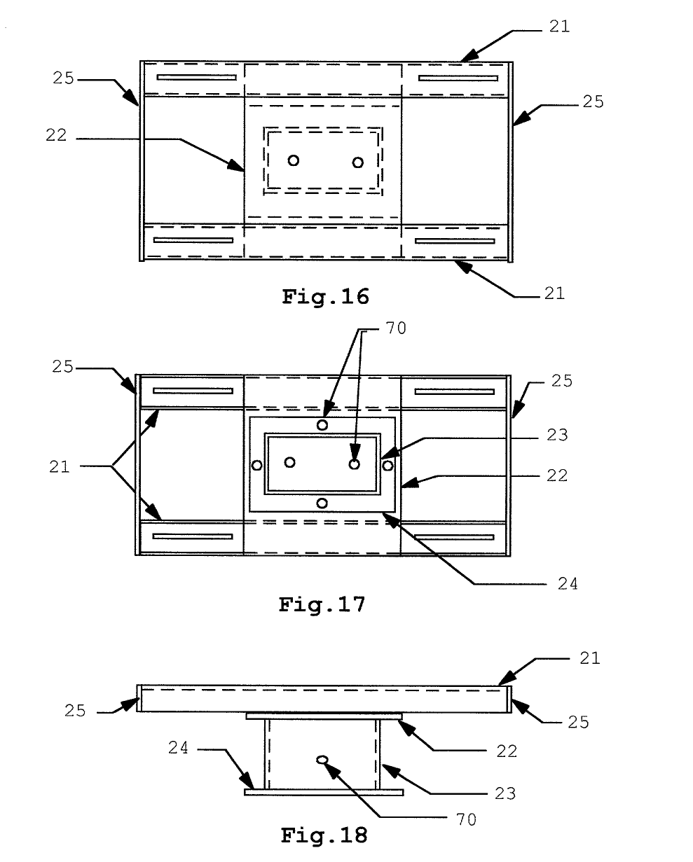

The assembled base unit assembly 20 consists of a welded base plate 22, with two supports and cabinet-mounting channels 21 built in as shown in FIG. 5, 14, 16, 17, and 18. The main cabinet unit assembly 10 is secured with four bolts 26 and locking washers 27 through four embossed, pre-drilled mounting holes 70 in the bottom of the main cabinet unit assembly 10 and in the assembled base unit assembly 20 as shown in FIG. 5. The package delivery and pickup receptacle system 01 may be installed and secured atop of a concrete base utilizing four bolts 26 and locking washers 27 through pre-drilled mounting holes 70 in the steel flange 24, of the assembled base unit assembly 20 as shown in FIGS. 17 and 18. Alternatively, the package delivery and pickup receptacle system 01 may be installed by mounting the square steel collar 23 of the assembled base unit assembly 20 (FIGS. 17 and 18) to a 4″×6″ treated lumber post buried in the ground.

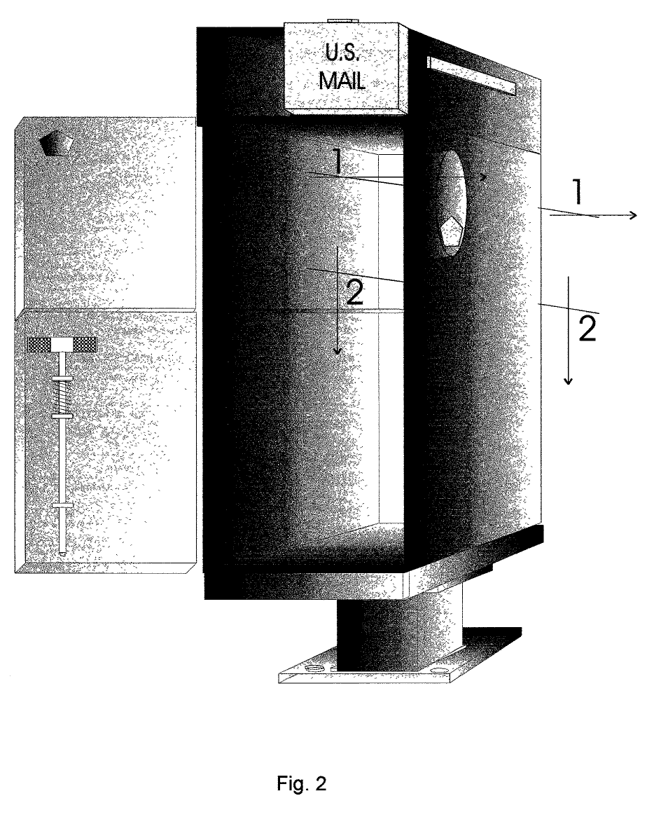

The mounting bars 19 on top of the package delivery and pickup receptacle system's 01 main cabinet unit 10 also include pre-drilled, threaded mounting holes 70 that accommodate the installation of a U.S. Mailbox 41, approved by the Postmaster General and a newspaper receptacle 43. The U.S. Mailbox 41 and newspaper receptacle 43, referred herein, have been previously designed and patented, are not intended to be new designs and are not included as claims in this patent application. However, the manufacturer of the package delivery and pickup receptacle system 01 may want to include an approved standard U.S. Mailbox 41 and newspaper receptacle 43 as part of a complete package delivery and pickup receptacle system 01, which is the preferred embodiment of the present invention as shown in FIGS. 1 and 2. Alternatively, the consumer may wish to purchase the U.S. Mailbox 41 and newspaper receptacle 43 separately and install either or both onto the package delivery and pickup receptacle system 01 at a later time.

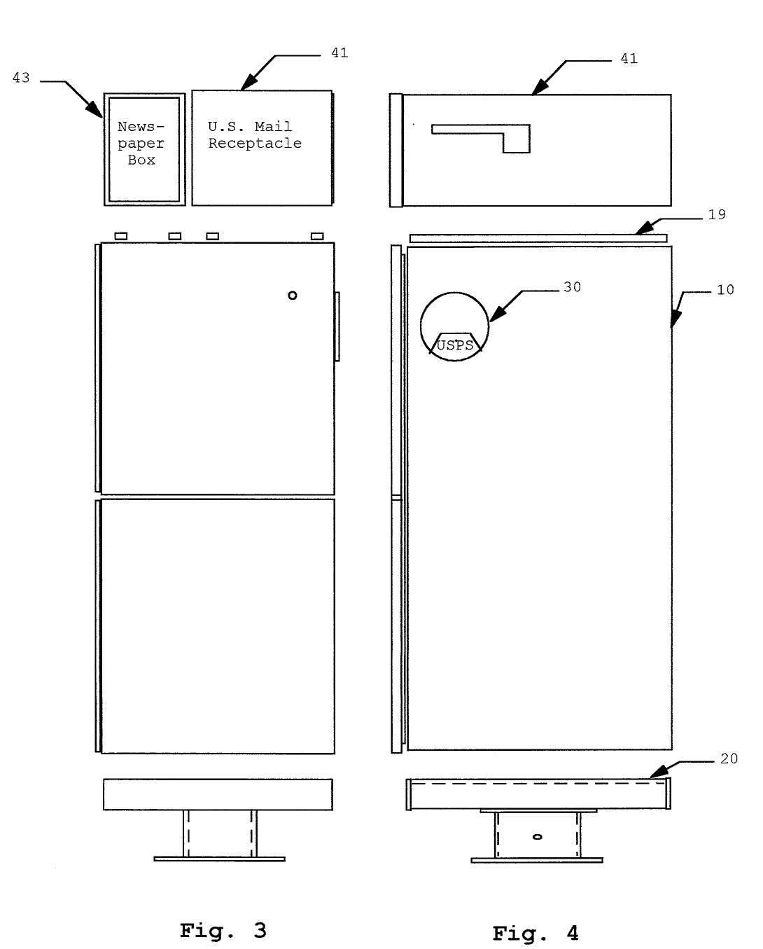

The preferred embodiment of the present invention, a package delivery and pickup receptacle system 01 that includes a U.S. Mailbox 41 and newspaper receptacle 43 (FIGS. 1 and 2) establishes a single and complete delivery receptacle for a variety of delivery and pickup services. These services include and are not limited to, the delivery of U.S. mail to the mailbox receptacle by the U.S. Postal Service only; package delivery and pickup service by all delivery firms; and newspaper delivery. Regardless, the package delivery and pickup receptacle system 01 that includes the main cabinet unit 10, mounted on the assemble base unit assembly 20, (FIGS. 3 and 4) may be used as a stand-alone unit for package delivery and pickup without the inclusion of a U.S. Mailbox 41 or newspaper receptacle 43.

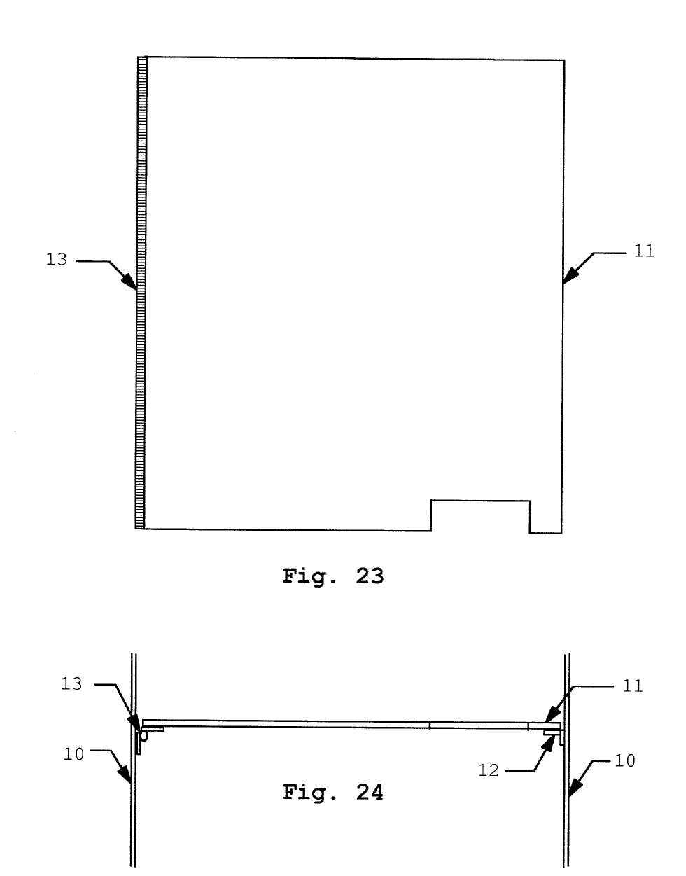

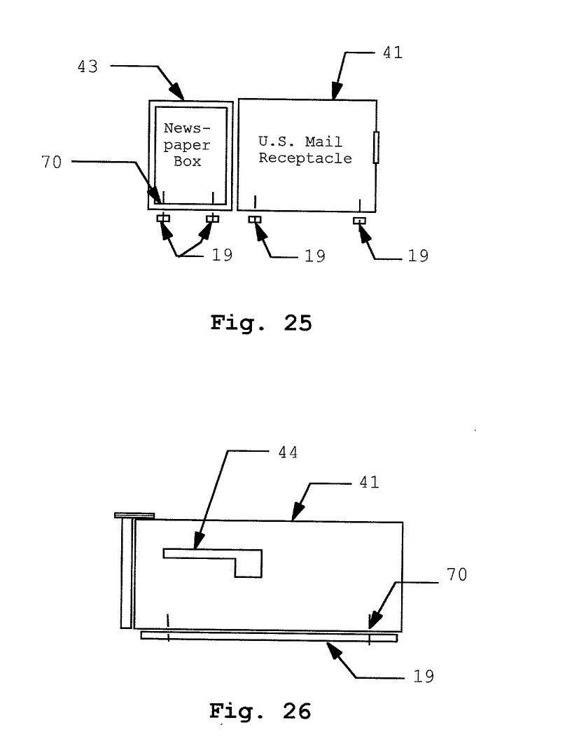

The package delivery and pickup receptacle system's 01 main cabinet unit 10 has an interior divider shelf 11 that is hinged 13 and positioned in the middle portion of the main cabinet unit 10 as shown in FIG. 5. The interior divider shelf 11 has a cutout in the front as shown in FIG. 23 that is used as a handle for raising or lowering the interior divider shelf 11 and for accessing the T-handle unit assembly 50. The interior divider shelf 11, when in the down position, rests on the angle support 12 as shown in FIGS. 5 and 24, and will accommodate a smaller package or packages in the upper portion of the main cabinet unit 10 without the need to access and use the entire main cabinet unit 10. In addition, by utilizing the divider shelf 11 in upper portion of the main cabinet unit 10 for one or more smaller packages, additional space is available for a second package in the lower portion of the main cabinet unit 10, eliminating the need to stack the parcels. The interior divider shelf 11 may be placed in the up position (FIG. 5) and is held by a magnet 18. In this position, a larger package and/or heavier package that requires more space than allowed with the divider shelf 11 in the down position can be deposited in the main cabinet unit 10. In addition, by placing heavier packages in the lower portion of the main cabinet unit 10 also protects smaller or lighter packages from potential damage from heavier weight packages.

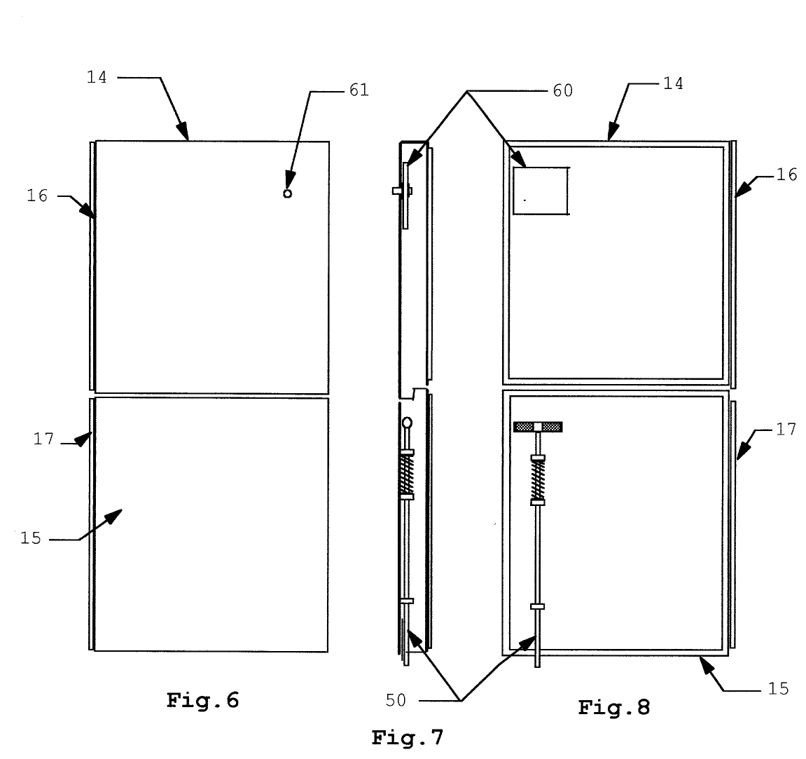

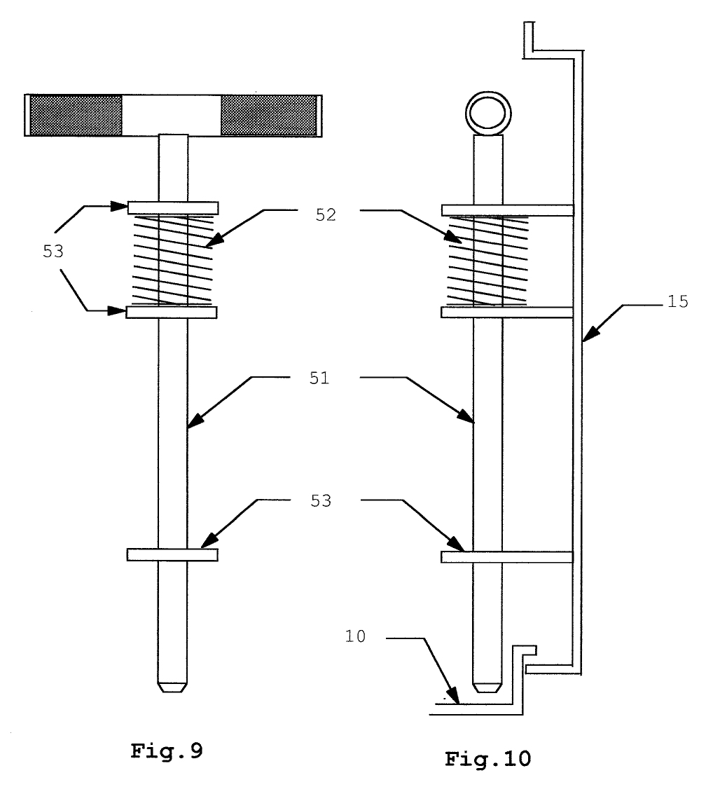

The package delivery and pickup receptacle system's 01 main cabinet unit 10 has two front doors 14 and 15 that cover the package delivery and pickup receptacle system's 01 main cabinet unit 10 as shown in FIGS. 1 through 8, 12 and 13. The upper door 14 is split from the lower door 15 at the same level as the interior divider shelf 11 (FIG. 5). This unique design permits access when only the upper door 14 is required to be opened to deposit a package. The unique, overlapping design of the top and bottom edges of the upper door 14 and lower door 15 as shown in FIGS. 10 and 12 are weatherproofing features that prevent damage from occurring to packages. The upper door 14 and lower door 15 are attached to the left side of the package delivery and pickup receptacle system's 01 main cabinet unit 10 with separate piano hinges 16 on the upper door and 17 on the lower door as shown in FIGS. 3, 5, 6, 7, 8 and 13. Attaching the upper and lower doors 14 and 15 on the left side of the main cabinet unit 10 allows easy access from a vehicle approaching from the right side of the street (the flow of traffic), allowing the doors to be opened from the right side. In a foreign country whose laws require driving on the left side of the road, the piano hinges, 16 and 17 may be used to attach the upper door 14 and lower door 15 on the right side of the package delivery and pickup receptacle system's 01 main cabinet unit 10.

The upper door 14 may have a standard national cam-lock assembly 60 as shown in FIGS. 2, 5, 7, 8 and 13 or may have any other appropriate locking mechanism installed by the manufacturer. This standard national cam-lock assembly supports a master key that would be used by delivery firms and a separate, unique key for each consumer who purchases the package delivery and pickup receptacle system 01. The master key would be made available only to delivery firms for their use and reproduction so that it can be used on all routes and would be provided to all delivery firms under an agreement to provide access to this universal package delivery and pickup receptacle system 01. Each package delivery and pickup receptacle system 01 would include two consumer keys when purchased by the consumer. There are many locking mechanisms that have been previously designed and patented and as any locking mechanism deemed appropriate by the manufacturer, these are not intended to be new designs and are not included as claims in this patent application.

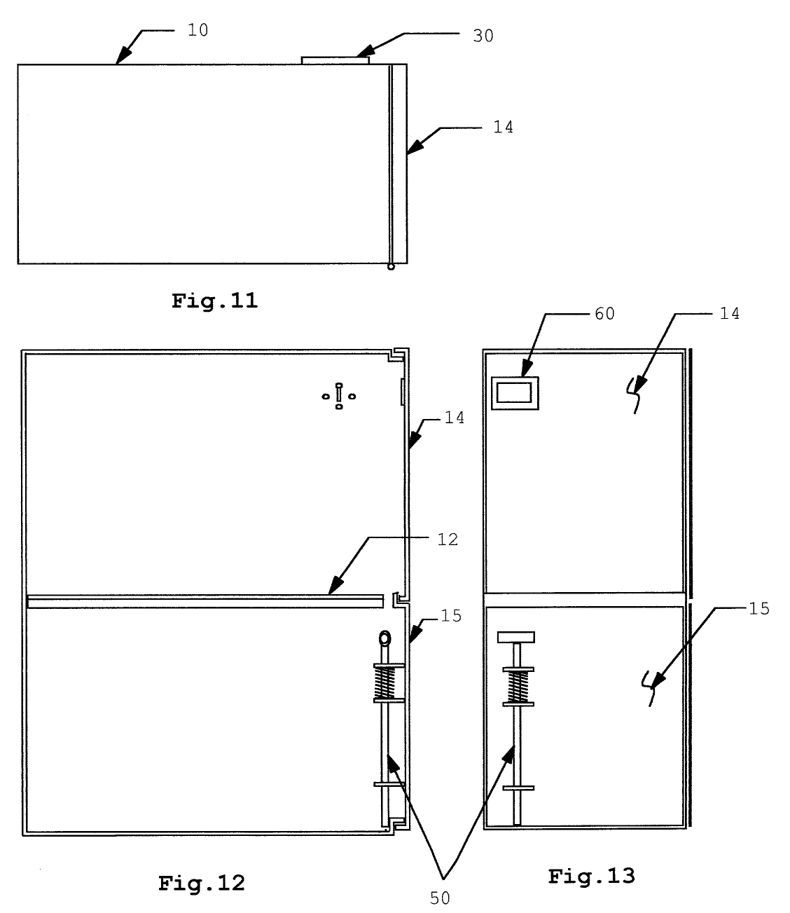

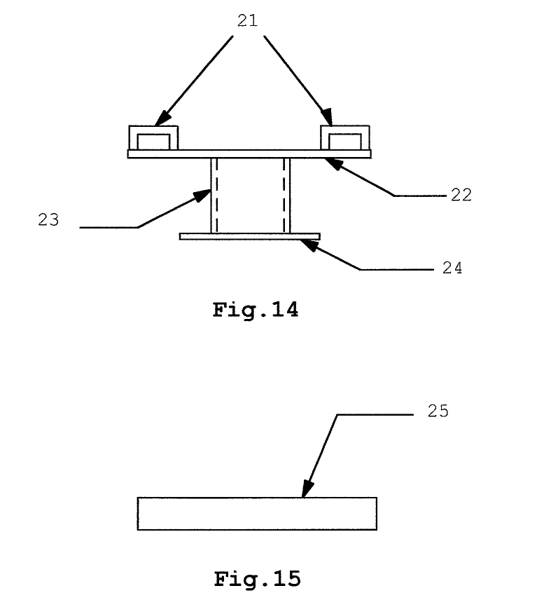

The lower door 15 has a T-handle door locking assembly 50, as shown in FIGS. 5 through 13 that keeps the lower door 15 closed when access is only required to the upper door 14 of the package delivery and pickup receptacle system's 01 main cabinet unit 10. The T-handle door locking assembly 50 is spring-loaded 52 and when the door is closed, catches on the inside lip of the package delivery and pickup receptacle system's 01 main cabinet unit 10 as shown in FIG. 10. When the lower door 15 needs to be opened to accommodate the deposit of a larger package, the delivery person will first unlock the upper door 14 and lift the divider shelf 11 into the raised position, ensuring that the divider shelf 11 is secured against the holding magnet 18. Once the divider shelf 11 is raised, the delivery person will reach inside the lower door 15 and pull up on the spring-loaded T-handle 51, of the lower door 15 T-handle unit locking assembly 50, opening the lower door 15.

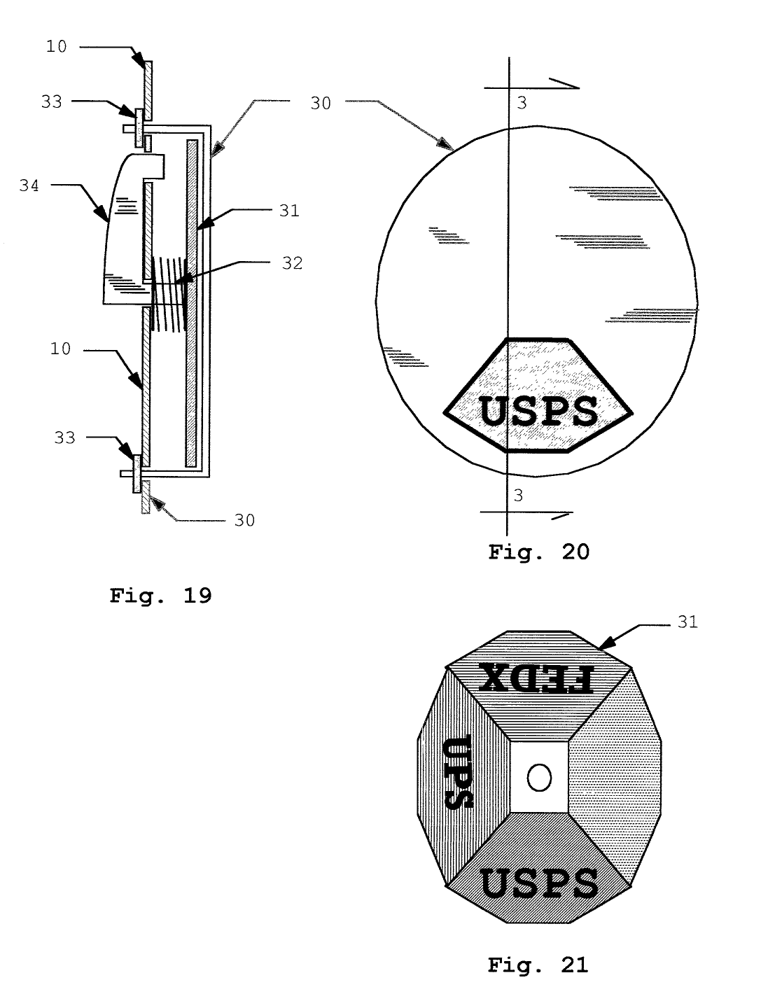

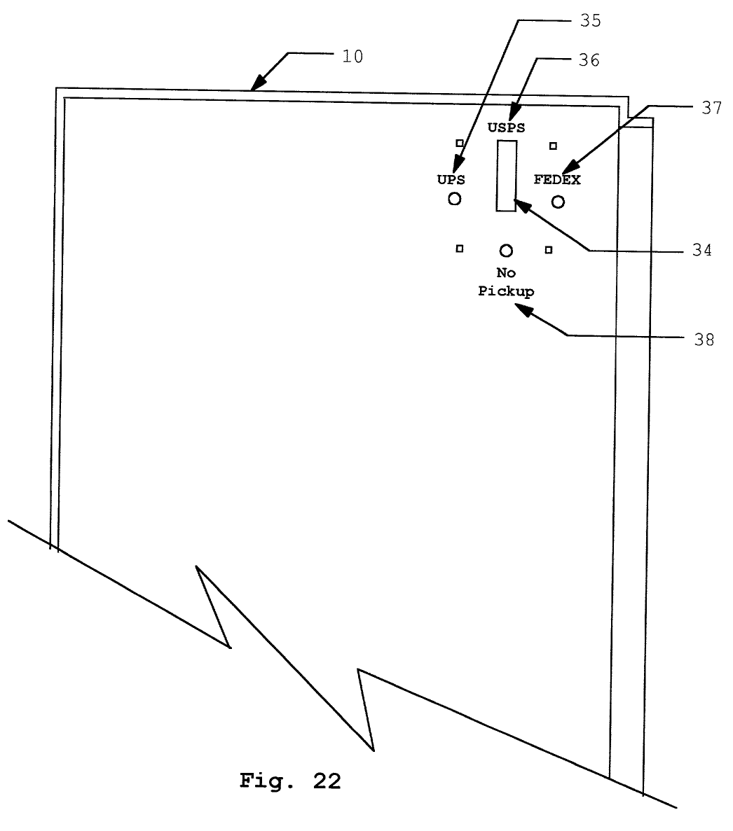

Incorporated into the right side of the package delivery and pickup receptacle system's 01, main cabinet unit 10 is a pickup-signaling device 30 as shown in FIGS. 1, 2, 4, 19, 20, 21 and 22. The pickup signaling device 30 alerts a delivery firm that the package they intend to pick up has been deposited by the customer and is enclosed in the main cabinet unit 10. After depositing a package that will be picked up by a delivery firm, the customer turns the delivery firm alert indicator selector 34 (FIG. 22) to select proper delivery firm identification label 35, 36, 37 or 38 to alert the delivery firm that a package has been deposited by the consumer for pickup.

We claim that our invention, the package delivery and pickup receptacle system is:

1. A package delivery and pickup receptacle system that is the first of its kind for residential or business use, that accommodates varying sizes and weights of packages that can be delivered to a secure, weatherproof container and does not require the consumer to be available to accept packages. This package delivery and pickup receptacle system meets a critical demand for secure and weatherproof place for goods and merchandise to be delivered when a consumer is not available to accept package. This is opposed to the current trend where packages are left on doorsteps, in rear yards, at a neighboring location or the customer must go to a delivery firms location to pickup the package. The expanded use of the Internet and significant increase in on-line purchasing that is placing greater demands on package delivery services.

2. A package delivery and pickup receptacle system that is the first of its kind for residential or business use that provides a secure and weatherproof place for goods and merchandise that are being returned to a retailer to be placed for pickup service by a delivery firm.

3. The package delivery and pickup receptacle system of claim 1 includes a locking mechanism with keys that can be used by delivery firms and consumers for greater security. This is opposed to the current methods used by delivery firms whereby they will deposit packages on doorsteps, behind bushes, in rear yards or at a neighboring home when a customer is not available to accept a package.

4. The package delivery and pickup receptacle system of claim 1 consists of a uniquely designed overlapping “Dutch-style” or split front door that offers greater security through the use of a T-Bar locking mechanism for the bottom door. The T-bar locking mechanism can only be accessed and the bottom door can only be opened when the upper door has been unlocked with a key and opened. Through the use of these dual locking mechanisms, only a single key-locking mechanism is needed.

5. The package delivery and pickup receptacle system of claim 1, with its uniquely designed overlapping split front door also offers greater weatherproofing as it seals off openings between the doors and the frame of the package delivery receptacle.

6. The unique design of the split front door on the package delivery and pickup receptacle in claim 1 is universal. That is, it may be attached (hinged) to the left side of the package delivery and pickup receptacle system in claim 1, offering ease of access and use by delivery vehicles that will approach the receptacle for delivery from the right side of the roadway. Alternatively, it may be attached (hinged) to the right side of the package delivery and pickup receptacle system for use in countries where driving is on the left side of the road.

7. The package delivery and pickup receptacle system of claim 1 also includes uniquely designed adjustable interior shelf that offers flexibility in the delivery or pickup process by accommodating multiple packages and packages of varying sizes.

8. The package delivery and pickup receptacle systems uniquely designed adjustable interior shelf offers a safety mechanism with a magnet that holds the shelf in place when placed in the raised position. When produced using polymers or plastics, Velcro strips may be used in place of a magnet. This permits easy access by the delivery person or customer when depositing or removing packages from the package delivery receptacle without incident.

9. The design of the top of the package delivery and pickup receptacle system of claim 1 provides for the easy addition or retrofitting of a pre-approved U.S. Mailbox or newspaper receptacle when purchased and installed separately by the consumer.

10. The unique design of the prefabricated base unit of the package delivery and pickup receptacle system in claim 1 provides for simple and easy installation at the appropriate height for delivery vehicles while offering greater stability to the overall unit.

11. The package delivery and pickup receptacle system of claim 1 has a signaling device incorporated into the outside of the receptacle's cabinet. This signaling device alerts the customer that a package has been delivered and conversely, alerts a delivery firm that the consumer has placed a package inside for pickup.

12. Because the package delivery and pickup receptacle system of claim 1 offers both security and weatherproofing, it is the first receptacle of its kind for residential or business use, that permits packages to be delivered on the first attempt regardless of whether a customer is available to accept a package. This provides opportunities for significant cost savings for merchandisers (the shippers), delivery firms and consumers. It eliminates added costs related to: damage from weather or theft when packages are left on doorsteps, behind bushes or in rear yards; multiple attempts to delivery the same package when no one is available to accept it; the need to return packages when delivery cannot be accomplished. It also eliminates the inconvenience to customers that may have to go to a retail location to pickup packages that could not be left when the customer was unavailable to accept the package.

13. The package delivery and pickup receptacle system of claim 1, for the first time offers the consumer a secure and weatherproof place to leave packages of goods and merchandise which are being returned for pickup service by an identified delivery service. The use of the package delivery receptacle for returns offers the same advantages of security and weatherproof that it offers packages that are being delivered.
